(19) United States
(12) Patent Application Publication
(10) Pub. No.: US 2016/0350615 A1
(43) Pub. Date: Dec. 1, 2016

(54) IMAGE PROCESSING APPARATUS, IMAGE PROCESSING METHOD, AND STORAGE MEDIUM STORING PROGRAM FOR EXECUTING IMAGE PROCESSING METHOD

(71) Applicant: CANON KABUSHIKI KAISHA, Tokyo (JP)

(72) Inventors: Kotaro Yano, Tokyo (JP); Ichiro Umeda, Tokyo (JP); Muling Guo, Kawasaki-shi (JP)

(21) Appl. No.: 15/159,683

(22) Filed: May 19, 2016

(30) Foreign Application Priority Data
May 25, 2015 (JP) 2015-105802

(51) Int. Cl. G06K 9/32; G06K 9/03; G06K 9/00

(52) U.S. Cl. CPC G06K 9/3241; G06K 9/00771; G06K 9/033; G06K 2209/21

(57) ABSTRACT

An image processing apparatus includes a setting unit that sets a detection area for detecting an object within an image captured by an image capturing apparatus and a correction unit that corrects a position of at least one of a plurality of detection areas to reduce a difference between angles corresponding to each detection area set by the setting unit and an image capturing direction of the image capturing apparatus.

### BACKGROUND

Field

Aspects of the present invention generally to an image processing apparatus, an image processing method, and a storage medium for storing a program for executing the image processing method that are in particular suitably used for detecting an object in an image.

Description of the Related Art

A system is conventionally proposed that analyzes an image captured by a monitoring camera, detects whether people have entered a monitoring area based on the result of the analysis, and reports the result of the detection. Another proposed system not only detects whether people have entered, but also counts the number of people who have passed through a monitoring area by tracking people in a screen and detecting a level of congestion from the number of people.

Japanese Patent Application Laid-Open No. 2009-211311 discusses a technique for detecting people from an image captured in a diagonally downward direction and counting the number of people who have crossed a measurement line set in a screen according to an instruction from a user.

However, in the technique discussed in Japanese Patent Application Laid-Open No. 2009-211311, an object detection area is set according to the instruction from the user, and thus might be set at a position where the object detection is difficult. Furthermore, for example, when the user sets a plurality of the areas, object measurement results obtained in such areas may not be accurately compared with each other if the areas differ from one another in an accuracy of the object detection. Such areas include, for example, the measurement line for detecting whether an object has crossed the line.

### SUMMARY OF THE INVENTION

An image processing apparatus includes a setting unit configured to set a detection area for detecting an object within an image captured by an image capturing apparatus and a correction unit configured to correct a position of at least one of a plurality of detection areas to reduce a difference between angles corresponding to each detection area set by the setting unit and an image capturing direction of the image capturing apparatus.

Further features of aspects of the present invention will become apparent from the following description of exemplary embodiments with reference to the attached drawings.

### BRIEF DESCRIPTION OF THE DRAWINGS

FIGS. 1A and 1B are each a diagram illustrating a condition of capturing an image of people and a captured image including the people.

FIG. 2 is a diagram illustrating a first example of a configuration of a management system.

FIG. 3 is a diagram illustrating a configuration of an image analysis apparatus.

FIG. 4 is a flowchart illustrating a first example of processing executed by the management system.

FIG. 5 is a diagram illustrating a first example of measurement areas before correction.

FIG. 6 is a diagram illustrating a first example of the measurement areas after the correction.

FIG. 7 is a diagram illustrating a relationship between the number of people and time.

FIG. 8 is a diagram illustrating a second example of a configuration of a management system.

FIG. 9 is a flowchart illustrating a second example of processing executed by the management system.

FIG. 10 is a diagram illustrating a second example of measurement areas before correction.

FIG. 11 is a diagram illustrating a second example of the measurement areas after the correction.

FIG. 12 is a diagram illustrating a third example of the configuration of the management system.

FIGS. 13A and 13B are each a diagram illustrating a third example of a measurement area before correction.

FIG. 14 is a diagram illustrating a third example of the measurement area after the correction.

### DESCRIPTION OF THE EMBODIMENTS

First, how exemplary embodiments described below have been conceived will be described.

The technique of detecting an object from an image captured by an image capturing apparatus, as discussed in Japanese Patent Application Laid-Open No. 2009-211311, can be employed to compare the results of measuring the number of people or the level of congestion in a plurality of areas. For example, the numbers of people present in a plurality of different areas (an entrance, a passage, and the like) within a single image captured by a monitoring camera installed in a store, may be measured and compared with each other, to determine an area which is congested or a store shelf which is popular. Such determinations can be similarly made by measuring the number of people present in a plurality of areas within images captured by a plurality of monitoring cameras installed in different locations of the store and comparing the number of people in the areas.

However, accurate comparison of people in the plurality of areas cannot be achieved by simply comparing the result of detecting the people in the plurality of areas. This is because accuracy of detecting people in the plurality of areas differs from one another due to the difference in an image capturing condition of the image capturing apparatus. The present inventors have focused on this point.

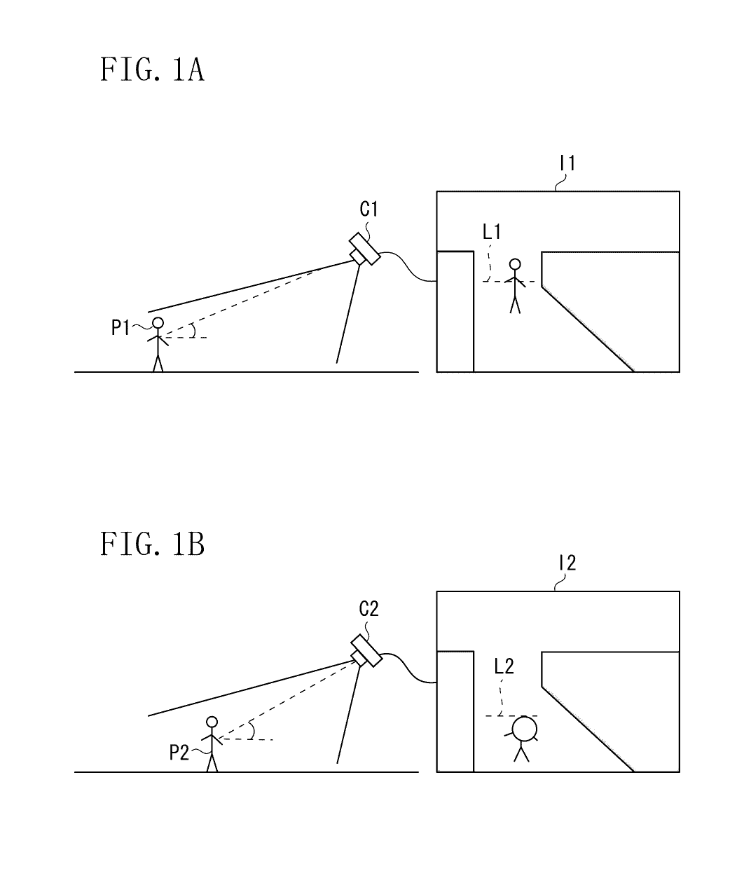

FIGS. 1A and 1B are diagrams respectively illustrating examples of image capturing conditions under which images of people P1 and people P2 are captured by image capturing apparatuses C1 and C2, and illustrating images I1 and I2 including the people P1 and the people P2 captured by the image capturing apparatuses C1 and C2. FIGS. 1A and 1B are different from each other in the image capturing conditions of the image capturing apparatuses C1 and C2 (orientations of the image capturing apparatuses C1 and C2 and the like). In FIG. 1A, the people P1 is detected on a line L1 set in the image I1, whereas the people P2 is detected on a line L2 set in the image I2.

It can be seen from a comparison between the images I1 and I2 illustrated in FIGS. 1A and 1B that the people P1 and the people P2 in the images thus captured, are shown differently. In the example illustrated in FIG. 1A, the position of the people P1 is far from the image capturing apparatus C1, and thus the image capturing apparatus C1 captures an approximately front image of the people P1. On the other hand, in the example illustrated in FIG. 1B, the position of the people P2 is close to the image capturing apparatus C2, and thus the image capturing apparatus C2 captures the image of the people P2 in a downward looking direction. Thus, it is likely that recognition of a feature of the people is difficult in the image capturing condition illustrated in FIG. 1B compared with the image capturing condition illustrated in FIG. 1A. As a result, in processing for detecting the people P1 and the people P2 from the images I1 and I2, there is a difference in accuracy for detecting people. In the image capturing condition illustrated in FIG. 1B, more failure occurs in detection of the people P2 compared with the image capturing condition illustrated in FIG. 1A. As a consequence, the number of people detected from the image I1 captured by the image capturing apparatus C1 and the number of people detected from the image I2 captured by the image capturing apparatus C2 may not be accurately compared with each other.

Based on the above described findings, our inventors have conceived the exemplary embodiments described below with reference to the drawings. According to the conceived embodiments, people can be accurately detected in each of a plurality of areas set within a captured image, and the results of detection of people can be accurately compared among the plurality of areas.

First, a first exemplary embodiment will be described. In the present exemplary embodiment, a case is described where the number of people (level of congestion) is compared between two areas set within a single captured image.

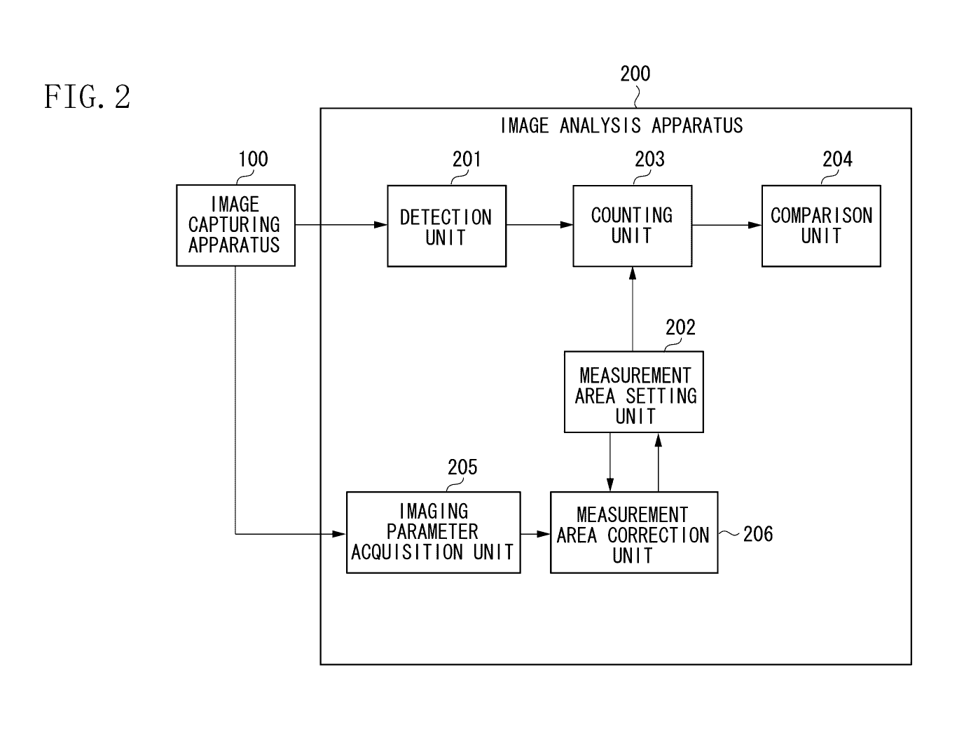

FIG. 2 is a diagram illustrating an example of a configuration of a management system.

As illustrated in FIG. 2, a management system according to the present exemplary embodiment includes an image capturing apparatus 100 and an image analysis apparatus 200.

The image analysis apparatus 200 includes a detection unit 201, a measurement area setting unit 202, a counting unit 203, a comparison unit 204, an imaging parameter acquisition unit 205, and a measurement area correction unit 206.

The image capturing apparatus 100 is, for example, a monitoring camera that captures a moving image of a monitoring target area and acquires image data. The image capturing apparatus 100 may capture still images also at different time points (captured at a predetermined time interval for example).

The detection unit 201 detects an object as a detection target from the image captured by the image capturing apparatus 100, and outputs the position of the object in the image. In the present exemplary embodiment, the detection unit 201 detects the position of people in the image.

The measurement area setting unit 202 sets a plurality of areas as targets for comparing the level of congestion of an object in the image acquired by the image capturing apparatus 100. The plurality of areas is set based on an operation performed on the image analysis apparatus 200 by a user. In the present exemplary embodiment, two areas are set, which are hereinafter referred to as “measurement area” as appropriate.

The counting unit 203 counts the number of objects detected by the detection unit 201 within each of the measurement areas set by the measurement area setting unit 202 . In the present exemplary embodiment, the counting unit 203 separately counts the number of people within each of the measurement areas.

The comparison unit 204 outputs information for comparing the number of objects measured by the counting unit 203 in the plurality of measurement areas.

The imaging parameter acquisition unit 205 acquires an imaging parameter of the image capturing apparatus 100.

The measurement area correction unit 206 corrects the position of at least one of the plurality of measurement areas, by using the positions of the plurality of measurement areas set by the measurement area setting unit 202 and the imaging parameter acquired by the imaging parameter acquisition unit 205.

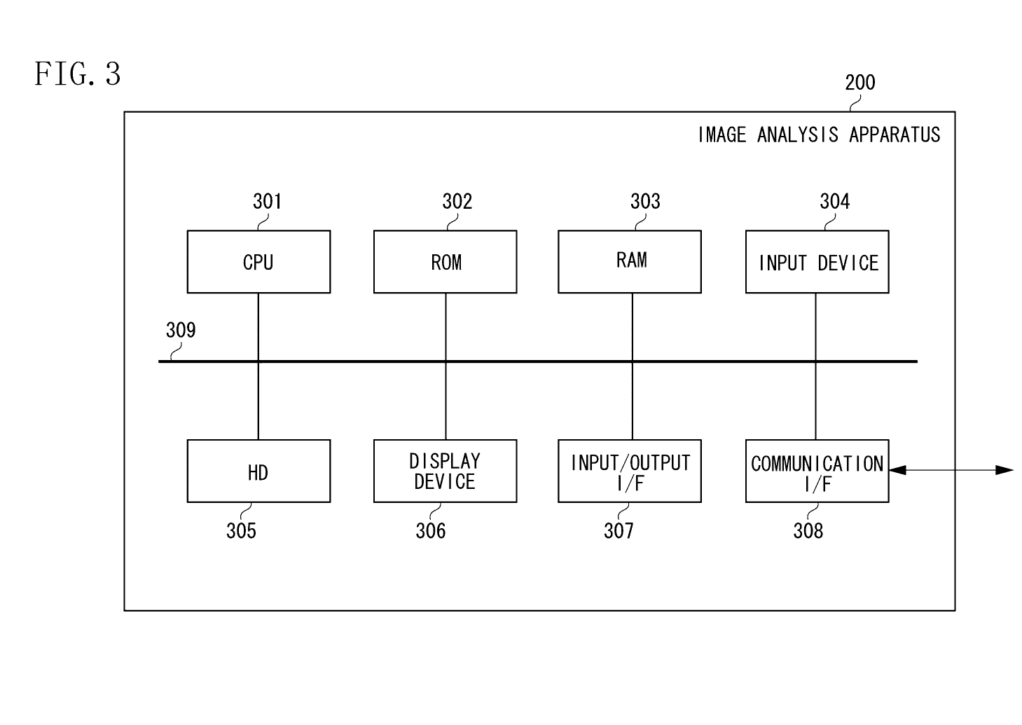

FIG. 3 is a diagram illustrating an example of a hardware configuration of the image analysis apparatus 200.

In FIG. 3, the image analysis apparatus 200 includes a central processing unit (CPU) 301, a read only memory (ROM) 302, and a random access memory (RAM) 303. The image analysis apparatus 200 further includes an input device 304, a hard disk (HD) 305, a display device 306, an input/output interface (I/F) 307, a communication I/F 308, and a system bus 309.

The CPU 301 performs overall control on processing in the image analysis apparatus 200 and controls the components (302 to 308) of the image analysis apparatus 200 via the system bus 309.

The ROM 302 stores an operating system (OS) as well as a Basic Input/Output System (BIOS) as a control program for the CPU 301. The ROM 302 stores a program and the like required for the CPU 301 to execute processing described below.

The RAM 303 functions a main memory, a work area, and the like for the CPU 301. To execute processing, the CPU 301 loads a necessary program from the ROM 302, necessary information from the HD 305, or the like onto the RAM 303. Then, the CPU 301 processes the program, the information, and the like to implement various types of processing. For example, the input device 304 is used by the user to input an operation to the image analysis apparatus 200 as appropriate. For example, the input device 304 includes at least one of a mouse, a keyboard, a touch panel, a button, and a switch.

The HD 305 serves as a storage unit that stores various types of data, files, and the like.

The display device 306 includes a computer display such as a liquid crystal display, and displays various types of information, images, and the like, based on control performed by the CPU 301.

The input/output I/F 307 outputs and receives data to and from a portable storage medium and the like.

The communication I/F 308 transmits and receives various types of information and the like to and from an external device via a network, a communication cable, or the like.

The system bus 309 is a bus that connects the CPU 301, the ROM 302, the RAM 303, the input device 304, the HD 305, the display device 306, the input/output I/F 307, and the communication I/F 308 with each other, in such a manner that the components can communicate with each other.

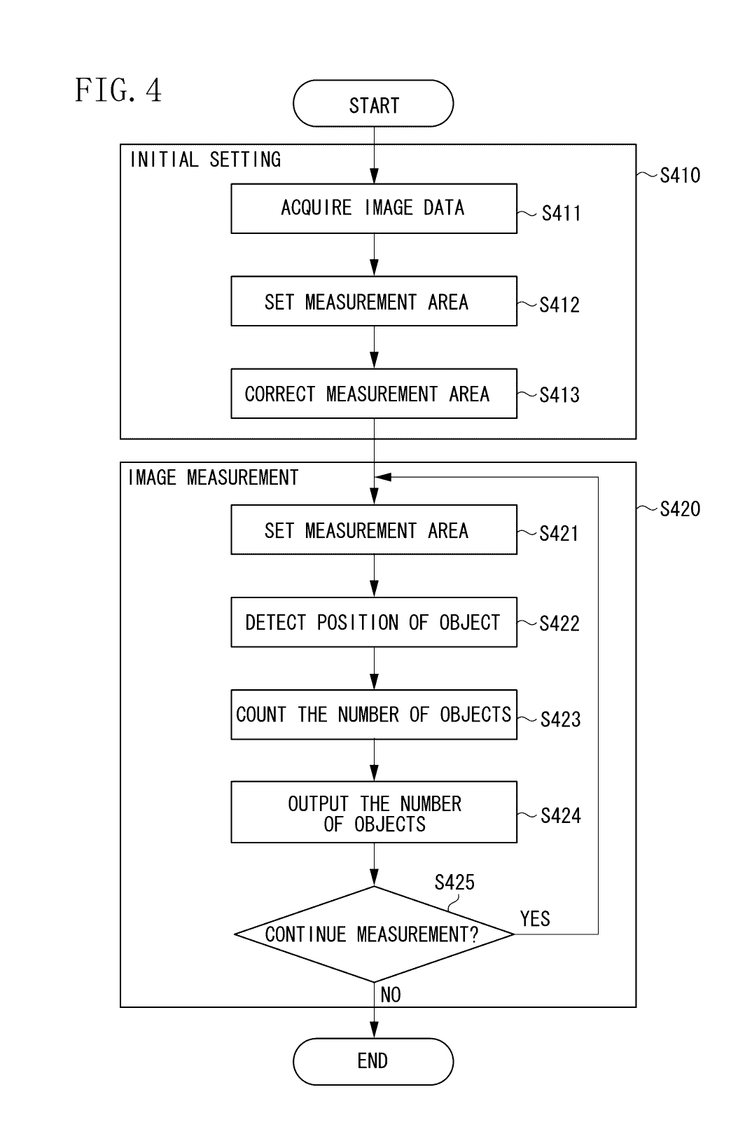

An example of processing executed in the management system according to the present exemplary embodiment is described below with reference to a flowchart illustrated in FIG. 4. As illustrated in FIG. 4, description of the processing in the management system is categorized into processing for initial setting (step S410) and processing for image measurement (step S420.

When the initial setting is performed, first, in step S411, the image capturing apparatus 100 captures an image of a monitoring target area, and acquires image data of the monitoring target area. The image data thus acquired is stored in a memory in the image capturing apparatus 100.

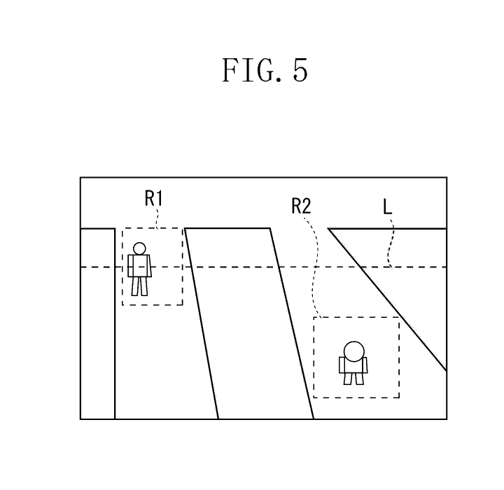

Next, in step S412, the measurement area setting unit 202 sets a measurement area. The measurement area setting unit 202 displays an image based on the image data acquired by the image capturing apparatus on the display device 306. The user sets a plurality of measurement areas in the image by operating the input device 304 while viewing the image thus displayed. FIG. 5 is a diagram illustrating an example of measurement areas before correction. Rectangular areas illustrated with broken lines in FIG. 5 represent measurement areas R1 and R2 set in the image based on the operation performed by the user. FIG. 5 illustrates a state where the measurement area R2 is set at a position closer to the image capturing apparatus 100 than the measurement area R1. Thus, it is likely difficult to detect people in the measurement area R2 than in the measurement area R1.

Next, in step S413, the measurement area correction unit 206 corrects a position of a measurement area, by using the positions of the plurality of measurement areas set by the measurement area setting unit 202 and the imaging parameter acquired by the imaging parameter acquisition unit 205. In an example illustrated in FIG. 5, the measurement area correction unit 206 obtains an angle between a ground (horizontal plane) and a straight line connecting between the camera center of the image capturing apparatus 100 and the center position in the measurement area R1 in an imaging plane of the image capturing apparatus 100. Then, the measurement area correction unit 206 causes an angle between the ground (horizontal plane), and a straight line connecting between the camera center of the image capturing apparatus 100 and the center position in the measurement area R2 in the imaging plane of the image capturing apparatus 100, to approximately match with the angle that has been obtained. Thus, the measurement area correction unit 206 causes angles of depression of the image capturing apparatus 100 relative to the measurement areas R1 and R2 to approximately match with each other. In other words, the measurement area correction unit 206 corrects the position of the measurement area R2 to achieve such a state. In this example, the measurement area correction unit 206 corrects the position of the measurement area R2 that is closer to the image capturing apparatus 100, out of the measurement areas R1 and R2 because it is more difficult to detect the people in the measurement area R2 than in the measurement area R1.

The imaging parameter acquired by the imaging parameter acquisition unit 205 includes an orientation (direction of the optical axis center) and a focal length of the image capturing apparatus 100. The measurement area correction unit 206 obtains the angle between the ground (horizontal plane) and the straight line connecting between the center position in the measurement area R1 and the camera center of the image capturing apparatus 100, by using the orientation and the focal length of the image capturing apparatus 100 and the position of the measurement area R1 set by the measurement area setting unit 202. The measurement area correction unit 206 acquires a line in the image, in which an angle relative to the ground surface (horizontal plane) becomes the same as the angle thus obtained. A straight line L illustrated in a dotted line in FIG. 5 represents the locus. The measurement area correction unit 206 corrects the center position of the measurement area R2 to be at a position on the straight line L closest to the center position of the measurement area R2. Thus, the measurement area correction unit 206 moves the measurement area R2 so that the center position of the measurement area R2 is positioned at the position on the straight line L closest to the center position of the measurement area R2.

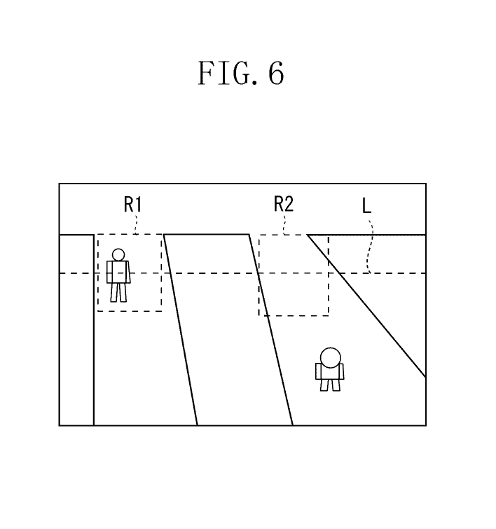

Grey areas in FIGS. 5 and 6 are areas where people never pass. Thus, the centers of the measurement areas R1 and R2 are prevented from being positioned in the grey areas in FIGS. 5 and 6. For example, the grey areas in FIGS. 5 and 6b are set based on an operation of the user inputting the measurement areas R1 and R2. Accordingly, the measurement areas R1 and R2 are set and corrected in the area where the people pass.

FIG. 6 is a diagram illustrating an example of the position of a measurement area after the correction. The measurement area correction unit 206 may correct the area of the measurement area R2 so that the sizes of the two measurement areas R1 and R2 in the physical space are set to be the same, based on the magnification. Further, the measurement area correction unit 206 can change the shape and the size of the measurement area R2 after the correction, or can change the shape and the size of the measurement area R2 according to the position after the correction so that (a major portion of) the measurement area is prevented from being positioned in the grey area illustrated in FIG. 6. In an example illustrated in FIG. 5, for the sake of simplicity, a case is described where the orientation of the image capturing apparatus 100 is set in such a manner that the distance between the image capturing apparatus 100 and the ground surface is the same along the horizontal direction in the image. In such a configuration, the angle between the ground surface (horizontal plane) and the straight line connecting between the camera center of the image capturing apparatus 100 and the center position of the measurement area in the imaging plane becomes coincident along a horizontal direction (lateral direction) in the image as indicated by the straight line L in FIG. 5.

The measurement area correction unit 206 outputs information including the center position of the measurement area corrected as described above. At the same time, the measurement area correction unit 206 outputs information indicating the size and the shape of the measurement area as appropriate. The measurement area setting unit 202 resets the measurement area according to the output from the measurement area correction unit 206.

Next, an example of processing (step S420) executed in the management system when the image measurement is performed will be described.

When the image measurement is performed, first, in step S421, the image capturing apparatus 100 captures an image of the monitoring target area, and acquires image data of the monitoring target area. The image data thus acquired is stored in the memory in the image capturing apparatus 100.

Next, in step S422, the detection unit 201 detects an object as a detection target from the image data acquired by the image capturing apparatus 100, and outputs the position of the object. The detection unit 201 can detect the position of the object through a known method. For example, the detection unit 201 gradually moves a partial area having a predetermined size and shape (while scanning), and clips an image corresponding to the partial area in this process. Then, the detection unit 201 obtains a Histograms of Oriented Gradients (HOG) feature amount, supplies the HOG feature amount thus obtained to a Support Vector Machine (SVM), and obtains an output from the SVM. The detection unit 201 detects people based on the output from the SVM.

For example, the detection unit 201 determines a partial area showing a determination value output from the SVM which is higher than a threshold, as the detection target object, and outputs the position of the object thus determined. To detect people of different sizes in the image, the detection unit 201 reduces an image by multiplying at a predetermined ratio (for example, by 0.8 or 0.8²) in advance, and performs the processing of detecting people also on each image thus reduced. The detection unit 201 may scan the partial area out of the entire area of the image, or may scan the measurement areas R1 and R2 set in the initial setting illustrated in FIG. 6.

Next, in step S423, the counting unit 203 counts the number of objects detected in each of the measurement areas set by the measurement area setting unit 202. More specifically, the counting unit 203 counts the number of the partial areas detected by the detection unit 201 which overlap in more than a predetermined area with the measurement area R1 set in step S412 and with the measurement area R2 corrected in step S413.

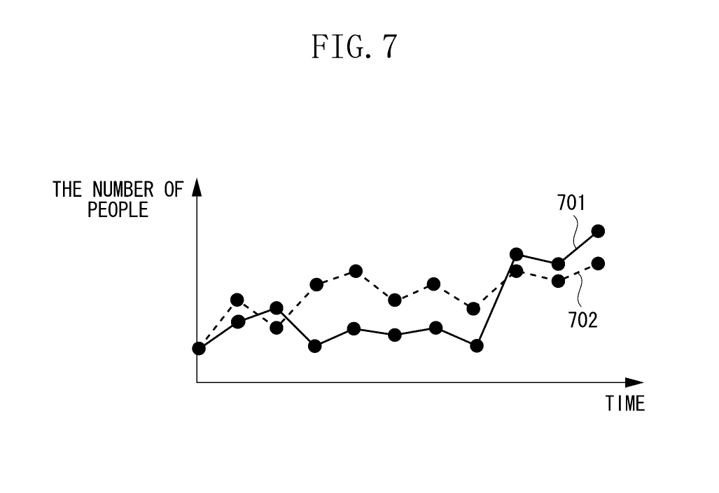

Next, in step S424, the comparison unit 204 outputs information for comparing the number of objects counted by the counting unit 203 in a plurality of measurement areas. For example, the comparison unit 204 displays the number of people counted by the counting unit 203 in each of the measurement areas R1 and R2 in a form of a numerical value on the display device 306. The comparison unit 204 may display the sum of the numbers of people counted in each of the measurement areas R1 and R2 in a form of a numerical value on the display device 306. The comparison unit 204 may display the number of people counted by the counting unit 203 in each of the measurement areas R1 and R2, in a form of a graph in which the horizontal axis represents time and the vertical axis represents the number of people as illustrated in FIG. 7, on the display device 306. In FIG. 7, a solid line 701 indicates a temporal change in the number of people counted in the measurement area R1, and a broken line 702 represents a temporal change in the number of people counted in the measurement area R2.

Next, in step S425, the image analysis apparatus 200 determines whether the measurement of the number of objects in each of measurement areas is to be continued based on an image captured at a subsequent time point. When it is determined that the measurement is to be continued (Yes in step S425), the processing returns to step S421 and the processing from step S421 to step S425 is repeated until it is determined that the measurement is to be terminated. Whether the measurement is to be terminated is determined based on an operation performed by the user, for example. When it is determined that the measurement is not to be continued (No in step S425), the processing in the flowchart illustrated in FIG. 4 is terminated.

As described above, in the present exemplary embodiment, the position of the measurement area R2 closer to the image capturing apparatus 100, is corrected in such a manner that the angles of depression of the image capturing apparatus 100 relative to the measurement areas R1 and R2 become approximately identical. Thus, a difference in detection accuracy can be reduced between directions in which the image capturing apparatus 100 captures the images of the people. As a consequence, higher comparison accuracy can be achieved in measuring the numbers of people in the plurality of measurement areas R1 and R2 within an image captured by the image capturing apparatus 100, so that the number of people can be accurately compared between the plurality of measurement areas R1 and R2.

Next, a second exemplary embodiment will be descried. In the first exemplary embodiment, a case is described where the numbers of people (levels of congestion) in two areas set in a single captured image area are compared with each other. In the present exemplary embodiment, a case is described where the number of people crossing two areas set in a single captured image is compared. In the present exemplary embodiment, a shape of the measurement area is different from the first exemplary embodiment, and processing of tracking an object is additionally performed. Thus, the present exemplary embodiment and the first exemplary embodiment are different from each other mainly in configuration and processing on the basis of these aspects. Therefore, the portions of the present exemplary embodiment described below that are the same as those in the first exemplary embodiment are denoted by the reference numerals that are the same as those in FIGS. 1 to 7, and will not be described in detail.

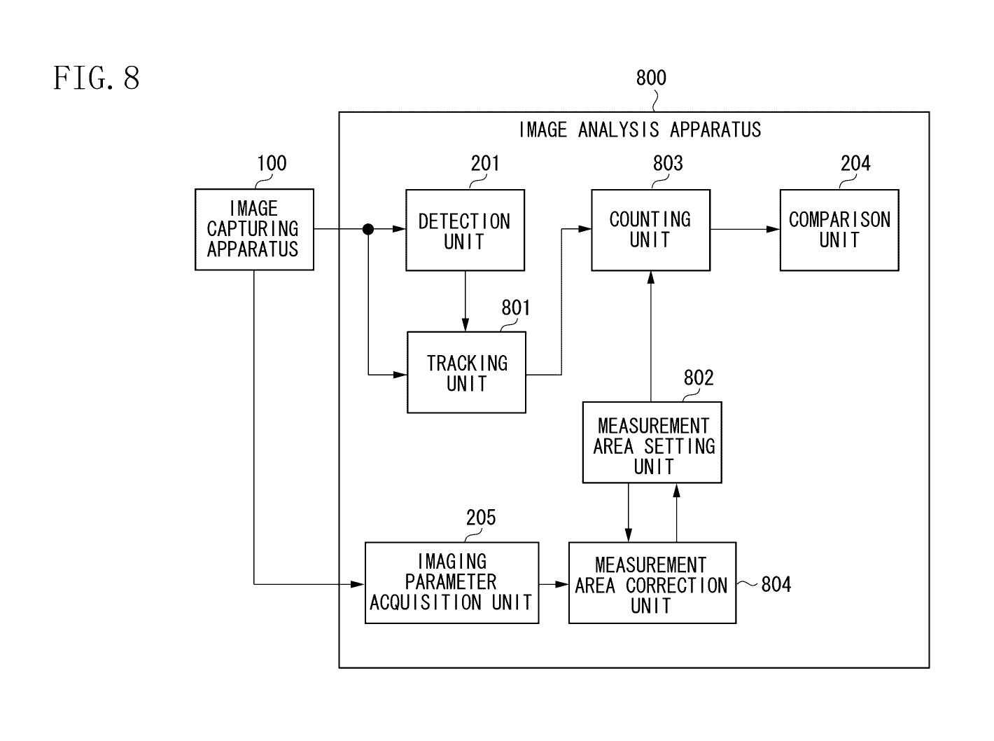

FIG. 8 is a diagram illustrating an example of a configuration of a management system.

As illustrated in FIG. 8, the management system according to the present exemplary embodiment includes the image capturing apparatus 100 and an image analysis apparatus 800.

The image analysis apparatus 800 includes the detection unit 201, the comparison unit 204, the imaging parameter acquisition unit 205, a tracking unit 801, a measurement area setting unit 802, a counting unit 803, and a measurement area correction unit 804. For example, the image analysis apparatus 800 may have the hardware configuration illustrated in FIG. 3.

The tracking unit 801 tracks an object as the detection target by using a latest image (image corresponding the current time point) acquired by the image capturing apparatus 100, and the position of the object detected by the detection unit 201 in the previous image acquired by the image capturing apparatus 100. In the present exemplary embodiment, the tracking unit 801 tracks the people within the image.

The measurement area setting unit 802 sets a plurality of detection lines used for comparing the number of objects that have crossed the detection lines in an image acquired by the image capturing apparatus 100. In the example described in the first exemplary embodiment, the measurement area has a shape of a rectangle. In the present exemplary embodiment, the measurement area has a shape of a line. The plurality of detection lines is set based on an operation performed by the user on the image analysis apparatus 800.

The counting unit 803 counts the number of objects that are tracked by the tracking unit 801 and that have crossed each of the detection lines set by the measurement area setting unit 802. In the present exemplary embodiment, the counting unit 803 counts the number of people who have crossed each of the detection lines.

The measurement area correction unit 804 corrects the position of at least one of the detection lines, by using the positions of the detection lines set by the measurement area setting unit 802 and the imaging parameter acquired by the imaging parameter acquisition unit 205.

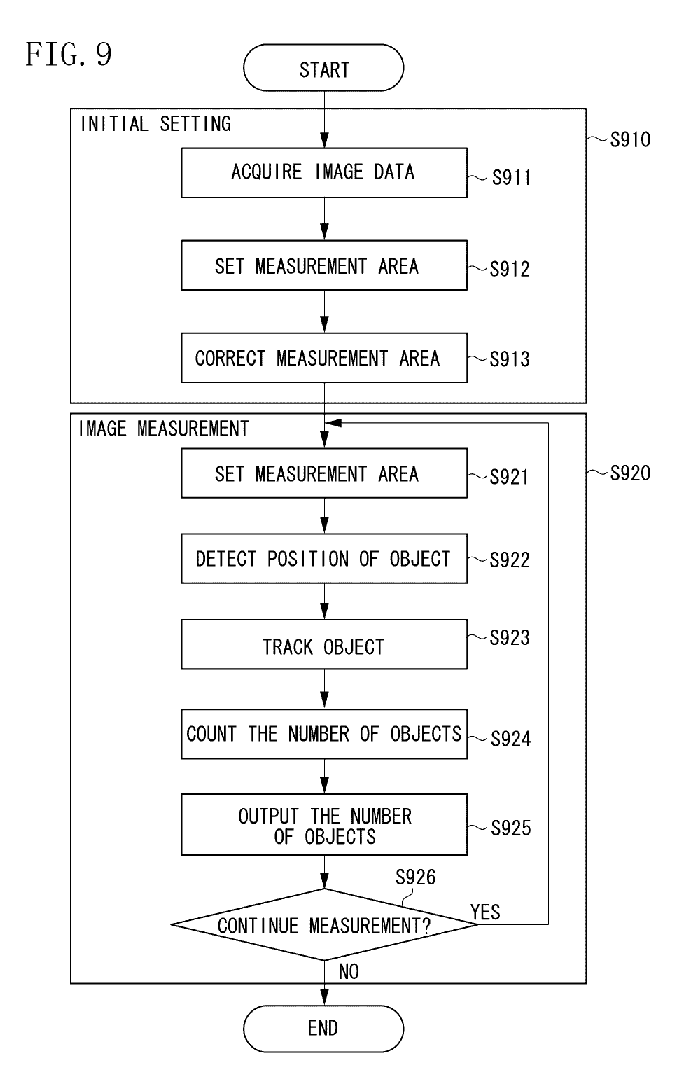

An example of the processing executed by the management system according to the present exemplary embodiment is described below with reference to a flowchart illustrated in FIG. 9.

When the initial setting is made, first, in step S911, the image capturing apparatus 100 captures an image of a monitoring target area, and acquires image data of the monitoring target area. The image data thus acquired is stored in the memory in the image capturing apparatus 100.

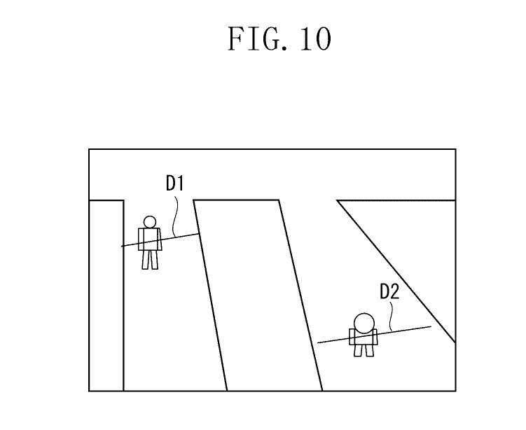

Next, in step S912, the measurement area setting unit 802 sets a measurement area (detection line). The measurement area setting unit 802 displays an image based on the image data acquired by the image capturing apparatus 100, on the display device 306. The user sets a plurality of the detection lines in the image by operating the input device 304 while viewing the image thus displayed. FIG. 10 is a diagram illustrating an example of measurement areas (detection lines) before correction. In FIG. 10, detection lines D1 and D2 are set in the image based on an operation performed by the user. In a state illustrated in FIG. 10, the detection line D2 is set to be closer to the image capturing apparatus 100 than the detection line D1. Thus, it is likely difficult to detect people in the neighborhood of the detection line D2 than in the neighborhood of the detection line D1.

Next, in step S913, the measurement area correction unit 804 corrects the position of the measurement area (detection line) by using the positions of the plurality of detection lines set by the measurement area setting unit 802 and by using the imaging parameter acquired by the imaging parameter acquisition unit 205. In the present exemplary embodiment, the measurement area correction unit 804 obtains an angle between the ground surface (horizontal plane) and a straight line connecting between the camera center of the image capturing apparatus 100 and the center position of the detection line D1 in the imaging plane of the image capturing apparatus 100. Then, the measurement area correction unit 804 causes an angle between the ground surface (horizontal plane) and a straight line connecting between the camera center of the image capturing apparatus 100 and a center position of the detection line D2 in the imaging plane of the image capturing apparatus 100 to approximately match with the angle thus obtained. Thus, the measurement area correction unit 804 causes the angles of depression of the image capturing apparatus 100 relative to the detection lines D1 and D2 to approximately match with each other.

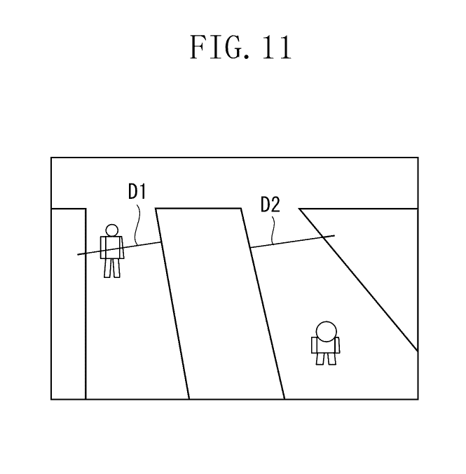

The measurement area correction unit 804 corrects the position of the detection line D2 to achieve such a state. In this example, the measurement area correction unit 804 corrects the position of the detection line D2 which is closer to the image capturing apparatus 100 than the detection line D1 because detection of people is difficult in the detection line D2 than in the detection line D1. The correction of the detection line can be implemented with a method similar to that for correcting the measurement area described in the first exemplary embodiment, and thus will not be described in detail herein. FIG. 11 is a diagram illustrating an example of the measurement areas (detection lines) after the correction. Grey areas in FIGS. 10 and 11 are areas where people never pass. Thus, the (entire) detection lines D1 and D2 are prevented from being positioned in the grey areas in FIGS. 10 and 11. For example, the areas in FIGS. 10 and 11 are set based on an operation performed by the user inputting the detection lines D1 and D2. Thus, the detection lines D1 and D2 are set and corrected in the areas where the people pass.

The measurement area correction unit 804 outputs information including the center position of the measurement area (detection line) thus corrected. At the same time, the measurement area correction unit 804 outputs information indicating the length and inclination of the measurement area (detection line) as appropriate. The measurement area setting unit 802 resets the measurement area (detection line) according to the output from the measurement area correction unit 804.

Next, an example of processing executed by the management system to perform image measurement will be described (step S920).

When the image measurement is performed, first, in step S921, the image capturing apparatus 100 captures an image of the monitoring target area, and acquires image data of the monitoring target area. The image data thus acquired is stored in the memory in the image capturing apparatus 100.

Next, in step S922, the detection unit 201 detects an object as a detection target from the image acquired by the image capturing apparatus 100, and outputs the position of the object. The processing in step S922 is the same as the processing in step S422 in FIG. 4 described in the first exemplary embodiment.

Next, in step S923, the tracking unit 801 tracks the object as the detection target by using the latest image (image at the current time point) acquired by the image capturing apparatus 100 and by using the position of the object detected by the detection unit 201 from the image previously acquired by the image capturing apparatus 100. The latest image acquired by the image capturing apparatus 100 represents an image acquired by the image capturing apparatus 100 at the current time point, and the previously acquired image represents an image acquired by the image capturing apparatus 100 at a last time point (frame) primarily preceding the current time point.

The tracking unit 801 first estimates the position of the object at the current time point based on the position of the object detected by the detection unit 201, from the image lastly acquired by the image capturing apparatus 100. For example, the estimation of the position of the object is implemented by using the Kalman filter.

Next, the tracking unit 801 gradually moves (i.e. scans) a partial area having a predetermined size and shape, and clips an image corresponding to the partial area from the image corresponding to the current time point as a predetermined range from the estimated position of the object is set as the searched area. The tracking unit 801 determines whether the image of the partial area corresponds to the position of the object as the detection target, by employing a method used by the detection unit 201 (the method of identifying people with the combination of the HOG feature value and the SVM). The tracking unit 801 determines the partial area in the searched area showing the largest determination value output from the SVM, as the position of the tracked object.

The tracking unit 801 determines that the tracking of the object as the detection target has failed when the determination value output from the SVM is equal to or smaller than a predetermined value. The tracking unit 801 searches the image corresponding to the current time point for an image of the partial area which is similar to the image of the partial area corresponding to the position of the object at the last time point. In this case, the search area is an area of a predetermined range centering on the estimated position of the object. The tracking unit 801 determines the partial area showing a highest degree of similarity in the searched area as the position of the tracked object. For example, a color histogram is used as the degree of similarity. The tracking unit 801 determines that the object has moved out of the monitoring target area when no partial area showing the degree of similarity that is equal to or higher than a threshold is found.

Next, in step S924, the counting unit 803 counts the number of objects that are tracked by the tracking unit 801 and have crossed each of the detection lines set by the measurement area setting unit 802. More specifically, out of partial areas tracked by the tracking unit 801, the counting unit 803 counts the number of the partial areas in which a locus along with the temporal change of the object position has crossed the detection line D1 set in step S912 and the detection line D2 corrected in step S913.

Next, in step S925, the comparison unit 204 outputs information used for comparing the numbers of objects that have crossed a plurality of detection lines counted by the counting unit 803. The information may be output in a form that is similar to that in a description on step S424 in FIG. 4.

Next, in step S926, the image analysis apparatus 800 determines whether the measurement of the number of objects that have crossed a plurality of detection lines is to be continued, based on an image captured at a subsequent time point. When it is determined that the measurement is to be continued (Yes in step S926), the processing returns to step S921, and the processing from step S921 to step S926 is repeated until it is determined that the measurement is to be terminated. For example, whether the measurement is to be terminated is determined based on an operation performed by the user. When it is determined that the measurement is not to be continued (No in step S926), the processing in the flowchart illustrated in FIG. 9 is terminated.

As described above, in the present exemplary embodiment, the position of the detection line D2 closer to the image capturing apparatus 100, is corrected in such a manner that the angles of depression of the image capturing apparatus 100 relative to the detection lines D1 and D2 approximately match with each other. Thus, a difference in detection accuracy can be reduced between directions in which the image capturing apparatus 100 captures the images of the people. As a consequence, measurement accuracy becomes higher in measuring the numbers of people who have crossed the plurality of detection lines D1 and D2, so that the numbers of people can be accurately compared with each other.

In the first and the second exemplary embodiments, the number of people is measured at two portions in a single captured image, and the result of the measurement is output. Alternatively, the number of people may be measured at equal to or more than three portions in a single image. In such a case, for example, the positions of the measurement areas that are not farthest from the image capturing apparatus may be corrected in such a manner that the angles of depression of the image capturing apparatus relative to these measurement areas match with the angle of depression of the image capturing apparatus relative to the measurement area that is farthest from the image capturing apparatus.

In the cases described in the first and the second exemplary embodiments, the image capturing apparatus and the image analysis apparatus are separate apparatuses. Alternatively, the image capturing apparatus may have the function of the image analysis apparatus.

Next, a third exemplary embodiment will be described. In the case described in the first exemplary embodiment, the numbers of people (levels of congestion) in two areas set in a single captured image are compared with each other. In the present exemplary embodiment, a case is described where the numbers of people (level of congestion) in at least one area set in respective images captured by a plurality of image capturing apparatuses, are compared. Thus, the present exemplary embodiment is different from the first exemplary embodiment mainly in configuration and processing due to the difference in the number of captured images. Thus, portions described in the present exemplary embodiment that are the same as those in the first exemplary embodiment are denoted by the same reference numerals as in FIGS. 1 to 7, and will not be described in detail.

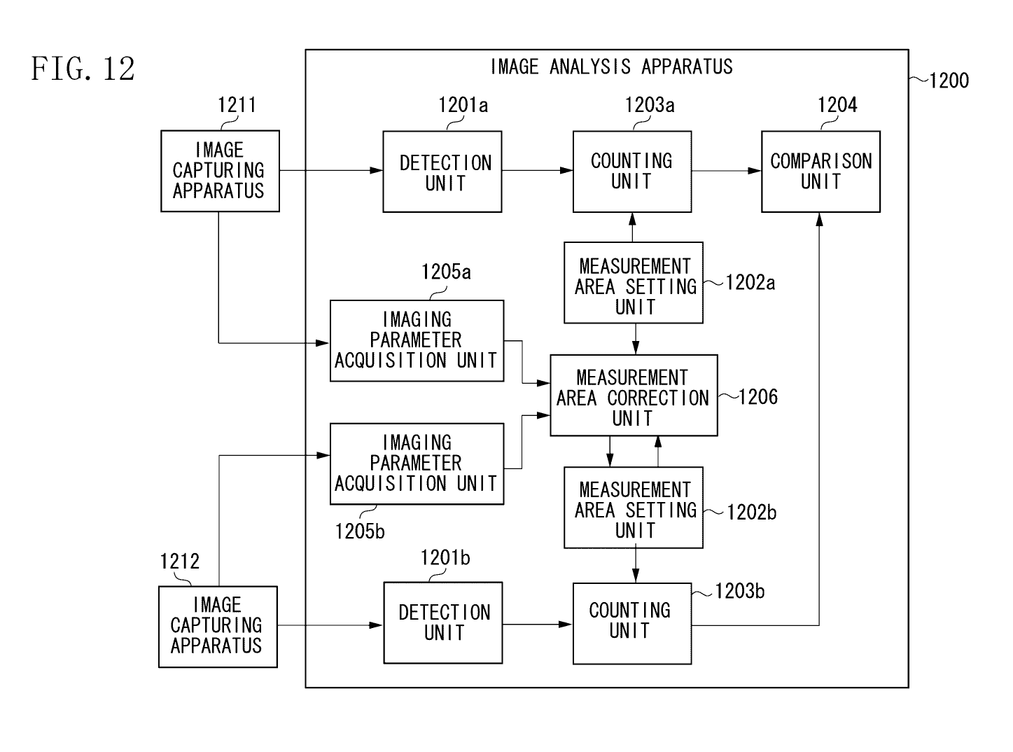

FIG. 12 is a diagram illustrating an example of a configuration of the management system.

As illustrated in FIG. 12, a management system according to the present exemplary embodiment includes image capturing apparatuses 1211 and 1212 and an image analysis apparatus 1200. In the present exemplary embodiment, the level of congestion is compared between images captured by the two image capturing apparatuses 1211 and 1212 installed in different locations.

The image capturing apparatuses 1211 and 1212 each have the same functions as the image capturing apparatus 100. For example, the image capturing apparatuses 1211 and 1212 are each a monitoring camera that captures a moving image of the monitoring target area and acquires image data. The image capturing apparatuses 1211 and 1212 capture images at locations in which the levels of congestion are compared.

The image analysis apparatus 1200 includes detection units 1201a and 1201b, measurement area setting units 1202a and 1202b, counting units 1203a and 1203b, a comparison unit 1204, imaging parameter acquisition units 1205a and 1205b, and a measurement area correction unit 1206. The image analysis apparatus 1200 may have a hardware configuration illustrated in FIG. 3, for example.

The detection unit 1201a, the measurement area setting unit 1202a, the counting unit 1203a, and the imaging parameter acquisition unit 1205a respectively have the same configurations as the detection unit 201, the measurement area setting unit 202, the counting unit 203, and the imaging parameter acquisition unit 205. The detection unit 1201b, the measurement area setting unit 1202b, the counting unit 1203b, and the imaging parameter acquisition unit 1205b respectively, have the same configurations as the detection unit 201, the measurement area setting unit 202, the counting unit 203, and the imaging parameter acquisition unit 205.

The detection unit 1201a, the measurement area setting unit 1202a, the counting unit 1203a, and the imaging parameter acquisition unit 1205a executes processing for the image capturing apparatus 1211. The detection unit 1201b, the measurement area setting unit 1202b, the counting unit 1203b, and the imaging parameter acquisition unit 1205b executes processing for the image capturing apparatus 1212. Thus, the detection unit 1201a, the measurement area setting unit 1202a, the counting unit 1203a, and the imaging parameter acquisition unit 1205a are different from the measurement area setting unit 1202b, the counting unit 1203b, and the imaging parameter acquisition unit 1205b, in image data (image capturing apparatus) as a processing target.

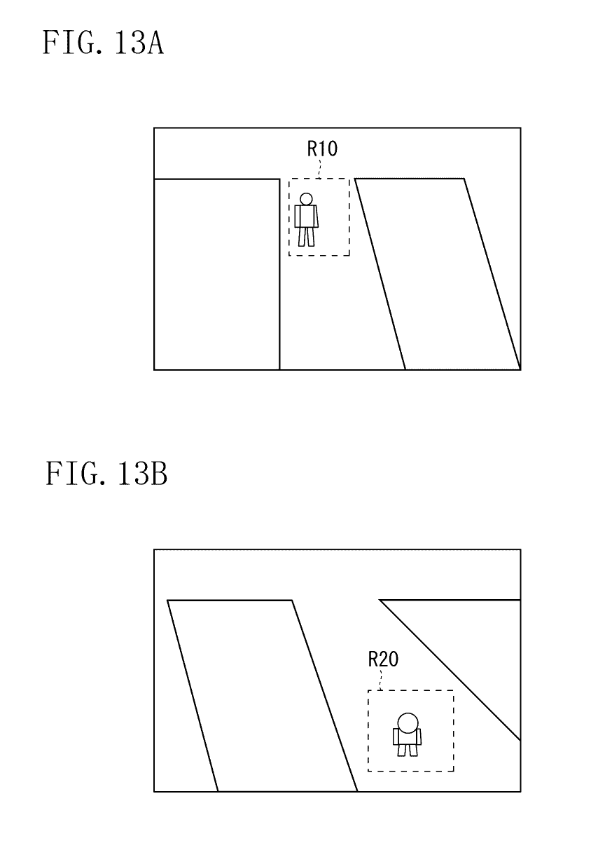

The measurement area setting unit 202 according to the first exemplary embodiment sets two measurement areas for an image acquired by the image capturing apparatus 100. On the other hand, the measurement area setting units 1202a and 1202b each sets a single measurement area in an image acquired by the image capturing apparatuses 1211 and 1212 (see FIG. 13). Alternatively, the measurement area setting units 1202a and 1202b may each set a plurality of measurement areas in an image acquired by the image capturing apparatuses 1211 and 1212.

The comparison unit 1204 outputs information for comparing the number of objects in a plurality of measurement areas measured by the counting units 1203a and 1203b.

The measurement area correction unit 1206 corrects at least one of the measurement areas by using the position of the measurement areas set by the measurement area setting units 1202a and 1202b, and by using the imaging parameters acquired by the imaging parameter acquisition units 1205a and 1205b.

In an example of a flowchart illustrating processing executed by the management system according to the present exemplary embodiment, the specific processing in each step is different from the flowchart illustrated in FIG. 4 described in the first exemplary embodiment, but can be implemented with the same steps (procedure) as the flowchart illustrated in FIG. 4. Thus, the example of the processing executed by the management system according to the present exemplary embodiment is described with reference to the flowchart illustrated in FIG. 4.

When an initial setting is performed, first, in step S411, each of the image capturing apparatuses 1211 and 1212 captures an image of a monitoring target area, and acquires image data of the monitoring target area. The image data thus acquired is stored in memories in the image capturing apparatuses 1211 and 1212.

Next, in step S412, each of the measurement area setting units 1202a and 1202b sets a measurement area.

The measurement area setting unit 1202a displays an image based on the image data acquired by the image capturing apparatus 1211 on the display device 306. The user sets a measurement area within the image by operating the input device 304 while viewing the image thus displayed. FIG. 13A is a diagram illustrating an example of a measurement area set on the basis of the image data acquired by the image capturing apparatus 1211. A rectangular area illustrated with a broken line in FIG. 13A represents a measurement area R10 set in the image based on the operation performed by the user.

Similarly, the measurement area setting unit 1202b displays an image based on the image data acquired by the image capturing apparatus 1212 on the display device 306. The user sets a measurement area within the image by operating the input device 304 while viewing the image thus displayed. FIG. 13B is a diagram illustrating an example of a measurement area set within the image based on the image data acquired by the image capturing apparatus 1212. A rectangular area illustrated with a broken line in FIG. 13B represents a measurement area R20 (before correction) set within the image based on the operation performed by the user.

Next, in step S413, the measurement area correction unit 1206 corrects a position of a measurement area, by using the positions of the measurement areas respectively set by the measurement area setting units 1202a and 1202b and the imaging parameters acquired by the imaging parameter acquisition units 1205a and 1205b. In the examples illustrated in FIGS. 13A and 13B, first, the measurement area correction unit 1206 obtains an angle between the ground surface (horizontal surface) and a straight line connecting between the camera center of the image capturing apparatus 1211 and the center position of the measurement area R10 in the imaging plane of the image capturing apparatus 1211. Then, the measurement area correction unit 1206 causes an angle between the ground surface (horizontal surface) and a straight line connecting between the camera center of the image capturing apparatus 1211, and the center position of the measurement area R20 in the imaging plane of the image capturing apparatus 1212 to approximately match with the angle thus obtained. More specifically, the measurement area correction unit 1206 causes the angles of depression of the image capturing apparatuses 1211 and 1212 relative to the measurement areas R10 and R20 to approximately match with each other.

The measurement area correction unit 1206 corrects the position of the measurement area R20 to achieve such a state. In this example, the measurement area correction unit 1206 corrects the position of the measurement area R20 which is closer to the image capturing apparatuses 1211 and 1212, out of the measurement areas R10 and R20, because it is more difficult to detect people in the measurement area R20 than in the measurement area R10.

The imaging parameter acquired by each of the imaging parameter acquisition units 1205a and 1205b includes an orientation (direction of the optical axis center) and a focal length of the image capturing apparatuses 1211 and 1212 respectively. The measurement area correction unit 1206 uses the imaging parameter and the position of the measurement area R10 set by the measurement area setting unit 1202a to obtain the angle between the ground surface (horizontal plane) and the straight line connecting between the camera center of the image capturing apparatus 1211 and the center position of the measurement area R10. Then, the measurement area correction unit 1206 obtains a locus in the image captured by the image capturing apparatus 1212 in which an angle relative to the ground surface (horizontal plane) that is the same as the angle thus acquired is obtained. The measurement area correction unit 1206 corrects the center position of the measurement area R20 to be at a position closest to the obtained locus. In other words, the measurement area correction unit 1206 moves the measurement area R20 such that the center position of the measurement area R2 is at the position closest to the obtained locus.

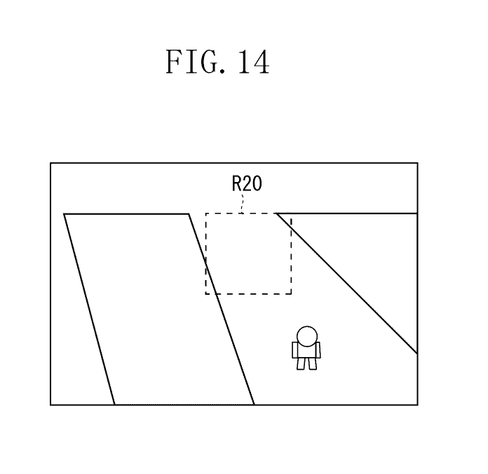

Grey areas in FIGS. 13 and 14 are areas where the people never pass. Thus, the centers of the measurement areas R10 and R20 are prevented from being positioned in the grey areas in FIGS. 13 and 14. For example, the grey areas in FIGS. 13 and 14 are set by an operation of the user inputting the measurement areas R10 and R20. Thus, the measurement areas R10 and R20 are set to be in an area where people pass. FIG. 14 illustrates an example of the position of the measurement area R20 after the correction. As described in the first exemplary embodiment, the measurement area correction unit 1206 may correct an area of the measurement area R20 such that the sizes of the measurement areas R10 and R20 become the same in physical space based on the imaging magnification. Furthermore, the measurement area correction unit 1206 can change the shape and the size of the measurement area R20 that has been corrected and can change the size and the shape of the measurement area R20 according to the corrected position so that (major portion of) the measurement area R20 is not positioned in the grey areas in FIG. 14.

The measurement area correction unit 1206 outputs information including the center position of the measurement area thus corrected. At the same time, the measurement area correction unit 1206 outputs information indicating the size and the shape of the measurement area as appropriate. The measurement area setting unit 1202 resets the measurement area according to the output from the measurement area correction unit 1206.

Next, an example of processing (step S420) executed by the management system for image measurement will be described.

When the image measurement is performed, first of all, in step S421, the image capturing apparatuses 1211 and 1212 each capture a monitoring target area, and acquires image data of the monitoring target area. The image data thus acquired is stored in the memories of the image capturing apparatuses 1211 and 1212.

Next, in step S422, the detection units 1201a and 1201b each detect an object as a detection target from the image data acquired by the image capturing apparatuses 1211 and 1212 respectively, and output the position of the object. For example, specific processing executed by the detection units 1201a and 1201b in step S422 can be implemented using the processing in step S422 described in the first exemplary embodiment.

Next, in step S423, the counting units 1203a and 1203b each count the number of objects detected by the detection units 1201a and 1201b respectively within the measurement area set by the measurement area setting units 1202a and 1202b respectively.

Next, in step S424, the comparison unit 1204 outputs information for comparing the numbers of objects in the measurement areas, counted by the counting units 1203a and 1203b. For example, specific processing executed by the comparison unit 1204 in step S424 can be implemented by replacing the measurement areas R1 and R2 respectively with the measurement areas R10 and R20 in the description on step S424 in the first exemplary embodiment.

Next, in step S425, the image analysis apparatus 1200 determines whether the measurement of the number of objects in the measurement areas is to be continued based on images captured by the image capturing apparatuses 1211 and 1212 at a subsequent time point. When it is determined that the measurement is to be continued (Yes in step S425), the processing returns to step S421 and the processing from step S421 to step S425 is repeated until it is determined that the measurement is to be terminated. When it is determined that the measurement is not to be continued (No in step S425), the processing in the flowchart illustrated in FIG. 4 is terminated.

As described above, in the present exemplary embodiment, the position of the measurement area R20 which is closer to the image capturing apparatus 1212, is corrected in such a manner that the angles of depression of the image capturing apparatuses 1211 and 1212 relative to the measurement areas R10 and R20 in the images separately captured by the two image capturing apparatuses 1211 and 1212, approximately match with each other. Thus, a difference in detection accuracy can be reduced between directions in which the images of people are captured by the image capturing apparatuses 1211 and 1212. Thus, the number of people in the measurement area can be measured accurately, as in the first exemplary embodiment, also for the plurality of measurement areas R10 and R20 respectively set for a plurality of images, and thus can be accurately compared with each other.

In the third exemplary embodiment, a case is described as an example where the numbers of people are measured by using the image capturing apparatuses 1211 and 1212 respectively installed in two locations, and the results of the measurements are compared with each other. Alternatively, the numbers of people can be measured by using image capturing apparatuses installed in three or more locations. In such as configuration, for example, the positions of other measurement areas can be corrected in such a manner that the angles of depression of the image capturing apparatuses relative to entire measurement areas match with the angle of depression of the image capturing apparatus relative to the farthest measurement area from the image capturing apparatus.

In the third exemplary embodiment, a case is described where the numbers of people (levels of congestion) in two measurement areas are compared. Alternatively, the third exemplary embodiment can be applied to a case where the numbers of people crossing each of two measurement areas are compared, as described in the second exemplary embodiment. For example, in such a configuration, instead of making the measurement areas R10 and R20 rectangular, the measurement areas R10 and R20 may be formed as the detection lines as described in the second exemplary embodiment. The detection target object is tracked, and the number of objects as the tracking target that have crossed the detection line is counted.

In the first to the third exemplary embodiments, the position of the measurement area (the rectangular area, the detection line, and the like) corrected by the measurement area correction unit 206, 804, or 1206 may be displayed on the display device 306 in a form illustrated in FIG. 6, 11, or 14. Thus, the user can check the measurement area after the correction. In such a configuration, the user who has determined that the corrected measurement area deviates from a desired measurement area can issue an instruction to change the position of the measurement area corrected by the image analysis apparatus, by operating the input device 304. Upon receiving such an instruction, the image analysis apparatus can reset the measurement area to be at the instructed (changed) position.

In the first to the third exemplary embodiments, a case is described where people are detected in an image. Alternatively, an object other than people may be the detection target.

Further, in the first to the third exemplary embodiments, a case is described where correction is performed to cause the angles of depression of the image capturing apparatus relative to all the measurement areas in the physical space to approximately match to facilitate the detection of objects. However, the configuration is not limited to such embodiments as long as the difference between angles of the image capturing apparatus for imaging the measurement areas can be reduced as a result of correction. This is because there might be cases where the angle of depression cannot be or should not be matched for all the measurement areas depending on a monitoring target area and a measurement area. Further, for example, correction may be made to approximately match angles of elevation of the image capturing apparatus relative to all the measurement areas in the physical space so that the detection of objects is facilitated. For example, this configuration can be employed when an image of a flying object is captured and detected from below. Furthermore, a correction may be made to cause angles in a horizontal direction of the image capturing apparatus relative to the measurement area in the physical space to approximately match with each other, instead of correcting angles in a vertical direction (angle of depression or elevation) relative to the measurement area in the physical space. For example, this configuration may be employed when an image of a flying object is captured and detected from a lateral direction.

In the first to the third exemplary embodiments, the position of a measurement area closer to the image capturing apparatus 100, 1211, or 1212 in the physical space is corrected to match with the position of a measurement area farther from the image capturing apparatus 100, 1211, or 1212 in the physical space. However, a configuration is not limited to the exemplary embodiments. Other configurations may be employed which corrects the position of at least one measurement area. For example, the positions of the measurement areas may be corrected in such a manner that the angles of depression of the image capturing apparatus relative to all the measurement areas become a predetermined angle or become an angle determined based on the imaging parameter and the like. With this configuration, for example, the measurement area can be corrected to be at an appropriate position even when the distance between the image capturing apparatus and each measurement area is short.

All the exemplary embodiments described above are merely examples of how aspects of the present invention are implemented, and thus do not limit the technical scope of the aspects of the present invention. Thus, aspects of the present invention can be implemented in various ways without departing from the technical idea and the main feature thereof. With the configurations of the exemplary embodiments, higher accuracy can be achieved in object measurement processing in a plurality of areas set within an image captured by an image capturing apparatus. Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-105802, filed May 25, 2015, which is hereby incorporated by reference herein in its entirety.

What is claimed is:

1. An image processing apparatus comprising:
a setting unit configured to set a detection area for detecting an object within an image captured by an image capturing apparatus; and
a correction unit configured to correct a position of at least one of a plurality of detection areas to reduce a difference between angles corresponding to each detection area set by the setting unit and an image capturing direction of the image capturing apparatus.

2. The image processing apparatus according to claim 1 further comprising a detection unit configured to execute detection processing for detecting the object in the plurality of detection areas including a detection area corrected by the correction unit.

3. The image processing apparatus according to claim 1 further comprising a display control unit configured to control a display screen to display the captured image,
wherein the setting unit is configured to set the detection area based on a user operation on the display screen on which the captured image is displayed.

4. The image processing apparatus according to claim 1 further comprising:
a counting unit configured to count a number of objects detected in each detection area including the detection area corrected by the correction unit; and
a display control unit configured to display the number of the objects counted by the counting unit.

5. The image processing apparatus according to claim 1 further comprising:
a counting unit configured to count a number of objects that have crossed an object detection line set as the detection area by the setting unit; and
a display control unit configured to display the number of the objects counted by the counting unit.

6. The image processing apparatus according to claim 1 further comprising an identification unit configured to identify a detection area farthest from the image capturing apparatus from among the plurality of detection areas set by the setting unit,
wherein the correction unit is configured to correct a position of detection areas other than the detection area identified by the identification unit from among the plurality of detection areas set by the setting unit.

7. The image processing apparatus according to claim further comprising an acquisition unit configured to acquire a parameter for identifying an image capturing direction of the image capturing apparatus and a parameter for identifying a shape of a physical space corresponding to detection areas set by the setting unit,
wherein the correction unit is configured to determine the angles by using information acquired by the acquisition unit.

8. The image processing apparatus according to claim 1 further comprising a display control unit configured to control a display screen to display a correction result obtained by the correction unit.

9. The image processing apparatus according to claim 1, wherein the correction unit is configured to correct a size of the detection area in response to correction of the position of the detection area set by the setting unit.

10. An image processing method comprising:
setting a detection area for detecting an object within an image captured by an image capturing apparatus; and
correcting a position of at least one of a plurality of detection areas to reduce a difference between angles corresponding to each set detection area and an image capturing direction of the image capturing apparatus.

11. The image processing method according to claim 10 further comprising detecting the object in the plurality of detection areas including a detection area that has been corrected.

12. The image processing method according to claim 10 further comprising controlling a display screen display the captured image,
wherein detection areas are set based on a user operation on the display screen on which the captured image is displayed.

13. A computer-readable storage medium storing computer executable instructions for causing a computer to execute a method comprising:
setting a detection area for detecting an object within an image captured by an image capturing apparatus; and
correcting a position of at least one of a plurality of detection areas to reduce a difference between angles corresponding to each set detection area and an image capturing direction of the image capturing apparatus.

14. The storage medium according to claim 13, wherein the method further comprises detecting the object in the plurality of detection areas including a detection area that has been corrected.

15. The storage medium according to claim 13 further comprising controlling a display screen to display the captured image,
wherein detection areas are set based on a user operation on the display screen on which the captured image is displayed.
